(19) United States
(12) Patent Application Publication
(10) Pub. No.: US 2017/0123560 A1
(43) Pub. Date: May 4, 2017

(54) METHOD FOR PERFORMING USER-INPUT CONTROL IN AN ELECTRONIC DEVICE, AND ASSOCIATED APPARATUS

(71) Applicant: MEDIATEK INC., Hsin-Chu (TW)

(72) Inventor: Chi-Shiang Kuo, Taipei City (TW)

(21) Appl. No.: 15/210,861

(22) Filed: Jul. 14, 2016

Related U.S. Application Data
(60) Provisional application No. 62/249,659, filed on Nov. 2, 2015.

(51) Int. Cl. G06F 3/041

(52) U.S. Cl. CPC G06F 3/0416; G06F 2203/04108

(57) ABSTRACT

A method for performing user-input control in an electronic device and an associated apparatus are provided, where the method may include the steps of: obtaining at least one touch parameter of a touch event regarding a touch-sensitive module of the electronic device; determining a touch force value associated with the touch event according to the aforementioned at least one touch parameter; and selecting a predetermined operation from a plurality of predetermined operations according to the touch force value, to control the electronic device to perform the predetermined operation in response to the touch force value. For example, the aforementioned at least one touch parameter of the touch event may be obtained from the touch-sensitive module or may be obtained by processing one or more detection signals received from the touch-sensitive module.

### CROSS REFERENCE TO RELATED APPLICATIONS

This application claims the benefit of U.S. Provisional Application No. 62/249,659, which was filed on Nov. 2, 2015, and is included herein by reference.

### BACKGROUND

The present invention relates to user-input detection, and more particularly to a method for performing user-input control in an electronic device, and an associated apparatus. For example, as a result of implementing the electronic device according to the method and the apparatus, one or more operations of the electronic device may be activated with aid of virtual force detection of a user input applied to the electronic device.

According to the related art, a conventional electronic device maybe equipped with a touch-sensitive module such as a touch-screen, to allow a user of the conventional electronic device to interact with the conventional electronic device through touching the touch-sensitive module. However, some problems may occur. For example, the touch-sensitive module cannot detect the pressure that a finger of the user applied to the touch-sensitive module. Although integrating pressure sensors into the touch-sensitive module may be proposed, associated costs (e.g. material and labor costs) may be increased due to adding the pressure sensors. In addition, this design may lead to an increased thickness of the touch-sensitive module, where there should be a physical limitation when trying to make the touch-sensitive module compact. Thus, a novel method and associated architecture are required for performing user-input control with aid of virtual force detection.

### SUMMARY

It is an objective of the claimed invention to provide a method for performing user-input control in an electronic device, and an associated apparatus, in order to solve the above-mentioned problems.

It is another objective of the claimed invention to provide a method for performing user-input control in an electronic device, and an associated apparatus, in order to control the electronic device with aid of virtual force detection.

According to at least one preferred embodiment, a method for performing user-input control in an electronic device is provided, where the method may comprise the steps of: obtaining at least one touch parameter of a touch event regarding a touch-sensitive module of the electronic device, wherein the touch-sensitive module does not comprise a pressure sensor; determining a touch force value associated with the touch event according to the at least one touch parameter; and selecting a predetermined operation from a plurality of predetermined operations according to the touch force value, to control the electronic device to perform the predetermined operation in response to the touch force value. For example, the aforementioned at least one touch parameter of the touch event may be obtained from the touch-sensitive module. In another example, the aforementioned at least one touch parameter of the touch event may be obtained by processing one or more detection signals received from the touch-sensitive module.

According to at least one preferred embodiment, an apparatus for performing user-input control in an electronic device is provided, where the apparatus may comprise at least one portion (e.g. a portion or all) of the electronic device. For example, the apparatus may comprise a processing circuit that is positioned within the electronic device and coupled to a touch-sensitive module of the electronic device. The processing circuit may be arranged for obtaining at least one touch parameter of a touch event regarding the touch-sensitive module of the electronic device, determining a touch force value associated with the touch event according to the at least one touch parameter, and selecting a predetermined operation from a plurality of predetermined operations according to the touch force value, to control the electronic device to perform the predetermined operation in response to the touch force value, wherein the touch-sensitive module does not comprise a pressure sensor. For example, the aforementioned at least one touch parameter of the touch event may be obtained from the touch-sensitive module. In another example, the aforementioned at least one touch parameter of the touch event may be obtained by processing one or more detection signals received from the touch-sensitive module, where the processing circuit may process the aforementioned one or more detection signals received from the touch-sensitive module, to generate the at least one touch parameter of the touch event.

It is an advantage of the present invention that the present invention method and apparatus can guarantee the overall performance of the whole system. In addition, the present invention method and apparatus can perform virtual force detection. As a result, the related art problems may no longer be an issue.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an apparatus for performing user-input control in an electronic device according to an embodiment of the present invention.

FIG. 2 illustrates a multifunctional mobile phone involved with the apparatus shown in FIG. 1 according to an embodiment of the present invention.

FIG. 3 illustrates a flowchart of a method for performing user-input control in an electronic device according to an embodiment of the present invention.

FIG. 4 illustrates a user input involved with the method shown in FIG. 3 according to an embodiment of the present invention.

FIG. 5 illustrates a user input involved with the method shown in FIG. 3 according to another embodiment of the present invention.

FIG. 6 illustrates implementation details of virtual force detection of the user input shown in FIG. 4 according to an embodiment of the present invention.

FIG. 7 illustrates implementation details of virtual force detection of the user input shown in FIG. 5 according to another embodiment of the present invention.

FIG. 8 illustrates a working flow involved with the method shown in FIG. 3 according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

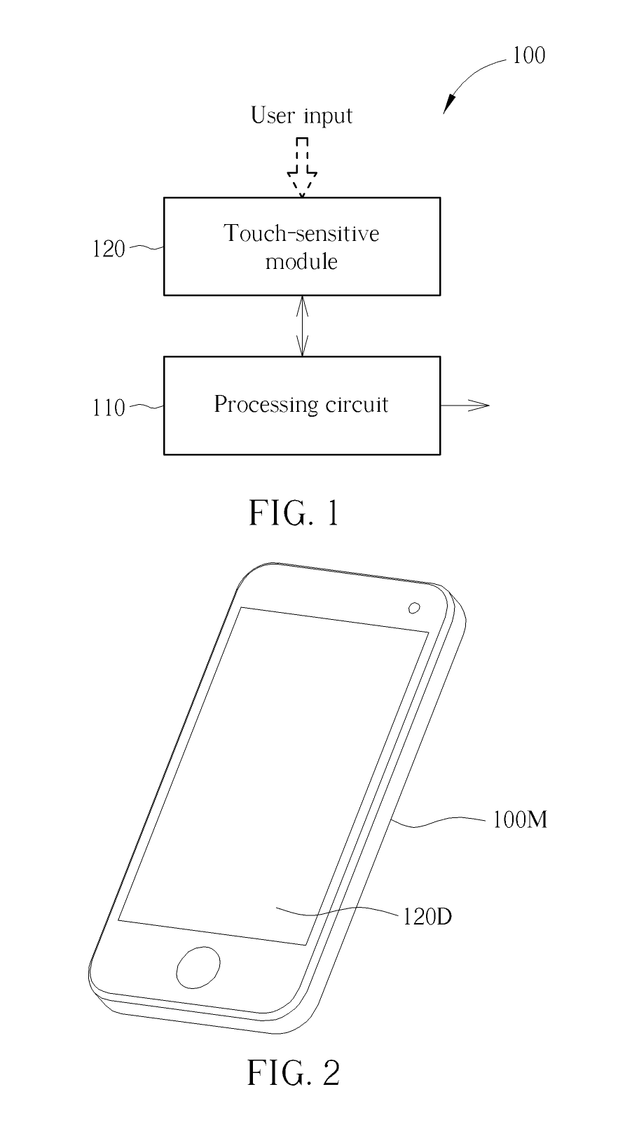

FIG. 1 is a diagram of an apparatus 100 for performing user-input control in an electronic device according to an embodiment of the present invention, where the apparatus 100 may comprise at least one portion (e.g. a portion or all) of the electronic device. In some embodiments, the apparatus 100 may comprise a portion of the electronic device mentioned above, and for example, can be at least one hardware circuit such as at least one integrated circuit (IC) within the electronic device and associated circuits thereof. In one or more other embodiments, the apparatus 100 can be the whole of the electronic device mentioned above. In some other embodiments, the apparatus 100 may comprise a system comprising the electronic device mentioned above (e.g. a wireless communications system comprising the electronic device). Examples of the electronic device may include, but not limited to, a multifunctional mobile phone, a tablet, a wearable device, an Internet of Things (IoT) device and a laptop computer.

As shown in FIG. 1, the apparatus 100 may comprise a processing circuit 110. For example, the processing circuit 110 may comprise at least one processor (e.g. one or more processors) and/or at least one processor core (e.g. one or more processor cores) for running program modules to control operations of the electronic device, and may further comprise some associated hardware circuits, where all of these components may be implemented on an IC such as that mentioned above. For better comprehension, a touch-sensitive module 120 of the electronic device is also illustrated in FIG. 1, where the processing circuit 110 and the touch-sensitive module 120 may be positioned within the electronic device, and maybe coupled to each other. Please note that the touch-sensitive module 120 of this embodiment does not comprise a pressure sensor. In some embodiments, the apparatus 100 may comprise only a portion of the architecture shown in FIG. 1, such as the processing circuit 110. In some embodiments, the processing circuit 110 may be implemented with a customized hardware circuit such as an application-specific integrated circuit (ASIC).

FIG. 2 illustrates a multifunctional mobile phone 100M involved with the apparatus 100 shown in FIG. 1 according to an embodiment of the present invention. For better comprehension, the multifunctional mobile phone 100M can be taken as an example of the electronic device, and the touch screen 120D can be taken as an example of the touch-sensitive module 120, where the touch screen 120D does not comprise any pressure sensor. For example, the multifunctional mobile phone 100M may comprise at least one processor (e.g. one or more processors) and/or at least one processor core (e.g. one or more processor cores) for running program modules to control operations of the multifunctional mobile phone 100M. According to this embodiment, the touch-sensitive module 120 such as the touch screen 120D does not comprise any pressure sensor. However, when the user of the electronic device touches the touch-sensitive module 120 such as the touch screen 120D, the apparatus 100 (e.g. the processing circuit 110) can perform virtual force detection on the user input that the user applied to the touch screen 120D. Thus, the multifunctional mobile phone 100M is capable of performing user-input control with aid of virtual force detection. As a result, the related art problems (e.g. the problem of increased costs due to adding pressure sensors, and the problem of increased thickness of the touch-sensitive module) may no longer be an issue.

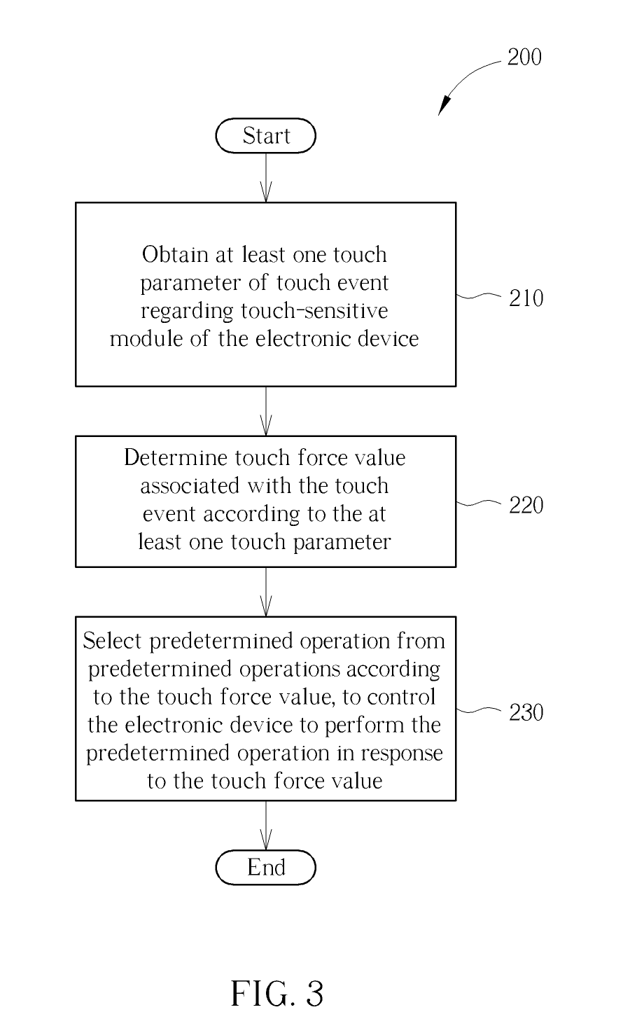

FIG. 3 illustrates a flowchart of a method 200 for performing user-input control in an electronic device according to an embodiment of the present invention. The method 200 can be applied to the apparatus 100 shown in FIG. 1 and the processing circuit 110 therein, and for example, can be applied to the multifunctional mobile phone 100M shown in FIG. 2. The method 200 can be described as follows.

In Step 210, the processing circuit 110 may obtain at least one touch parameter (e.g. one or more touch parameters) of a touch event regarding the touch-sensitive module 120 of the electronic device. For example, the aforementioned at least one touch parameter may include, but not limited to, an estimated touch point (e.g. the location thereof), an estimated area, an estimated duration, an estimated proximity value, an estimated touch action (e.g. down, up, move, etc.), and any of other types of parameters associated with the touch event. According to some embodiments, the processing circuit 110 may receive one or more detection signals from the touch-sensitive module 120 and process the one or more detection signals to generate the aforementioned at least one touch parameter of the touch event. Thus, the aforementioned at least one touch parameter of the touch event may be obtained by processing the one or more detection signals received from the touch-sensitive module 120. According to some embodiments, at least one internal component of the touch-sensitive module 120 may process the one or more detection signals to generate the aforementioned at least one touch parameter of the touch event. Thus, the aforementioned at least one touch parameter of the touch event may be obtained from the touch-sensitive module 120.

In Step 220, the processing circuit 110 may determine a touch force value associated with the touch event according to the aforementioned at least one touch parameter, the touch force value may indicate the force that the user of the electronic device applies to the touch-sensitive module 120 in the touch event. For example, the aforementioned at least one touch parameter may comprise an estimated area associated with the touch event, such as the area that the fingertip of a finger of the user touches the touch-sensitive module 120, where the touch force value maybe positively correlated with the estimated area. In another example, the aforementioned at least one touch parameter may comprise an estimated duration associated with the touch event, such as the duration that the fingertip of a finger of the user touches the touch-sensitive module 120, where the touch force value may be positively correlated with the estimated duration. In yet another example, the aforementioned at least one touch parameter may comprise an estimated proximity value associated with the touch event, such as the distance between the fingertip of a finger of the user and the touch-sensitive module 120, where the touch force value may be positively correlated with the estimated proximity value.

In Step 230, the processing circuit 110 may select a predetermined operation from a plurality of predetermined operations according to the touch force value, to control the electronic device to perform the predetermined operation in response to the touch force value. For example, there maybe a plurality of candidate touch force values corresponding to different ranges of the aforementioned at least one touch parameter, and the processing circuit 110 may select one of the plurality of candidate touch force values as the touch force value according to the range(s) that the touch parameter(s) (e.g. the estimated area, the estimated duration, and/or the estimated proximity value) falls within. In another example, the processing circuit 110 may calculate the touch force value according to the touch parameter(s).

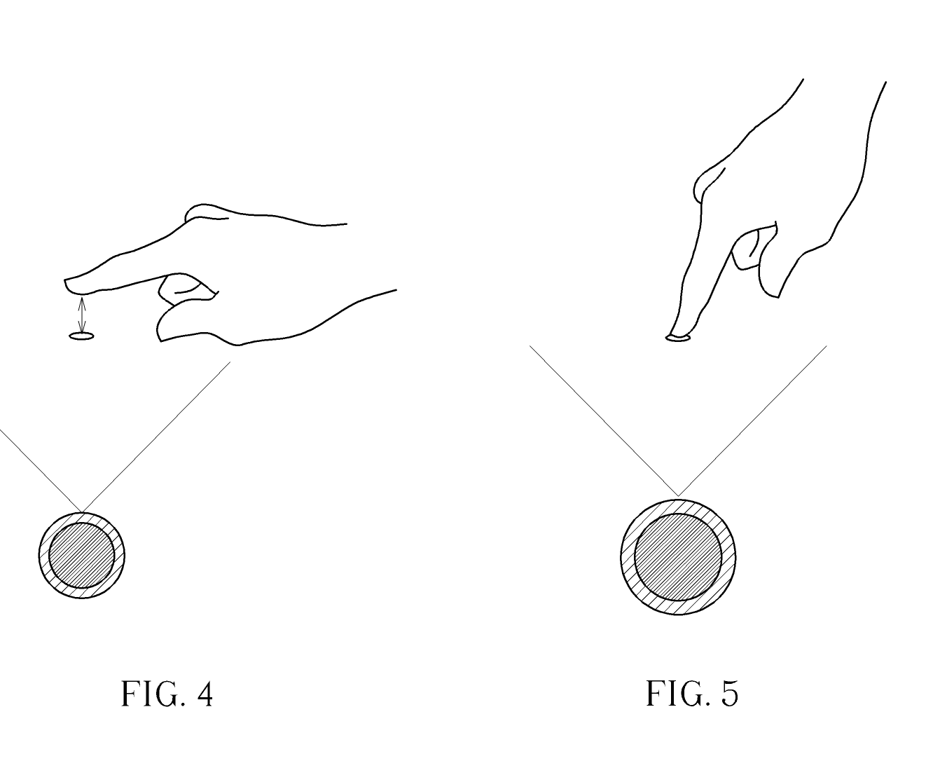

FIG. 4 illustrates a user input involved with the method 200 shown in FIG. 3 according to an embodiment of the present invention. For example, the user input may be a tap. Based on the method 200 shown in FIG. 3, the processing circuit 110 may determine the touch force value through virtual force detection and classify the user input of this embodiment as alight touch (rather than a heavy touch), and may select the predetermined operation corresponding to the light touch from the plurality of predetermined operations according to the touch force value. For example, a small value of the estimated area may cause the processing circuit 110 to classify the user input as the light touch (rather than the heavy touch). In another example, a small value of the estimated duration may cause the processing circuit 110 to classify the user input as the light touch (rather than the heavy touch). In still another example, the combination of a small value of the estimated area and a small value of the estimated duration may cause the processing circuit 110 to classify the user input as the light touch (rather than the heavy touch). For brevity, similar descriptions for this embodiment are not repeated in detail here.

FIG. 5 illustrates a user input involved with the method 200 shown in FIG. 3 according to another embodiment of the present invention. For example, the user input may be a press. Based on the method 200 shown in FIG. 3, the processing circuit 110 may determine the touch force value through virtual force detection and classify the user input of this embodiment as the heavy touch (rather than the light touch), and may select the predetermined operation corresponding to the light touch from the plurality of predetermined operations according to the touch force value. For example, a large value of the estimated area may cause the processing circuit 110 to classify the user input as the heavy touch (rather than the light touch). In another example, a large value of the estimated duration may cause the processing circuit 110 to classify the user input as the heavy touch (rather than the light touch). In still another example, a combination of a large value of the estimated area and a large value of the estimated duration may cause the processing circuit 110 to classify the user input as the heavy touch (rather than the light touch). For brevity, similar descriptions for this embodiment are not repeated in detail here.

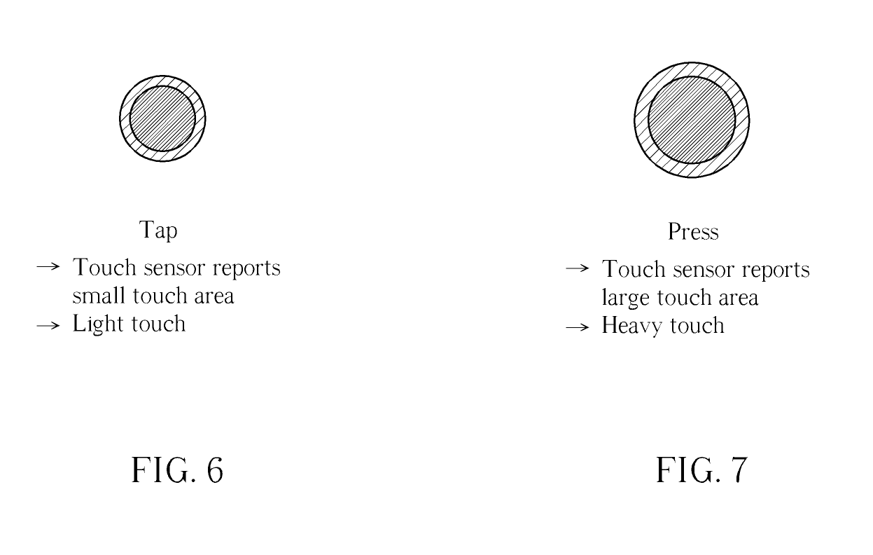

FIG. 6 illustrates implementation details of virtual force detection of the user input shown in FIG. 4 according to an embodiment of the present invention, and FIG. 7 illustrates implementation details of virtual force detection of the user input shown in FIG. 5 according to another embodiment of the present invention. According to the embodiments respectively shown in FIG. 6 and FIG. 7, the processing circuit 110 may comprise a touch sensor controller (labeled “Touch sensor” in each of FIG. 6 and FIG. 7, for brevity) for performing the operation of Step 210. For example, when the user input shown in FIG. 4 is applied to the touch-sensitive module 120, the touch sensor controller may report that the touch area of this user input is a small touch area, causing the processing circuit 110 to classify the user input as the light touch (rather than the heavy touch). In addition, when the user input shown in FIG. 5 is applied to the touch-sensitive module 120, the touch sensor controller may report that the touch area of this user input is a large touch area, causing the processing circuit 110 to classify the user input as the heavy touch (rather than the light touch). For example, the touch sensor controller may report that the touch area of this user input is a small touch area when the estimated area associated with the touch event falls within a first area range and report that the touch area is a large touch area when the estimated area associated with the touch event falls within a second area range. For brevity, similar descriptions for these embodiments are not repeated in detail here.

In general, the processing circuit 110 may be arranged for obtaining the aforementioned at least one touch parameter of the touch event regarding the touch-sensitive module 120 of the electronic device. For example, the aforementioned at least one touch parameter maybe obtained by processing the aforementioned one or more detection signals received from the touch-sensitive module 120, where the processing circuit 110 may process the aforementioned one or more detection signals received from the touch-sensitive module 120, to generate aforementioned at least one touch parameter of the touch event. This is for illustrative purposes only, and is not meant to be a limitation of the present invention. According to some embodiments, the architecture of the electronic device may vary. For example, in a situation where the touch sensor controller is positioned outside the processing circuit 110, the touch sensor controller may be integrated into the touch-sensitive module 120. As a result, the aforementioned at least one touch parameter of the touch event may be obtained from the touch-sensitive module 120, rather than being obtained from internal of the processing circuit 110. According to one or more of these embodiments, while the touch sensor controller may perform the operation of Step 210, an application processor within the aforementioned at least one processor and/or a processor core of the application processor may perform the operation of Step 220 and the operation of Step 230. For brevity, similar descriptions for these embodiments are not repeated in detail here.

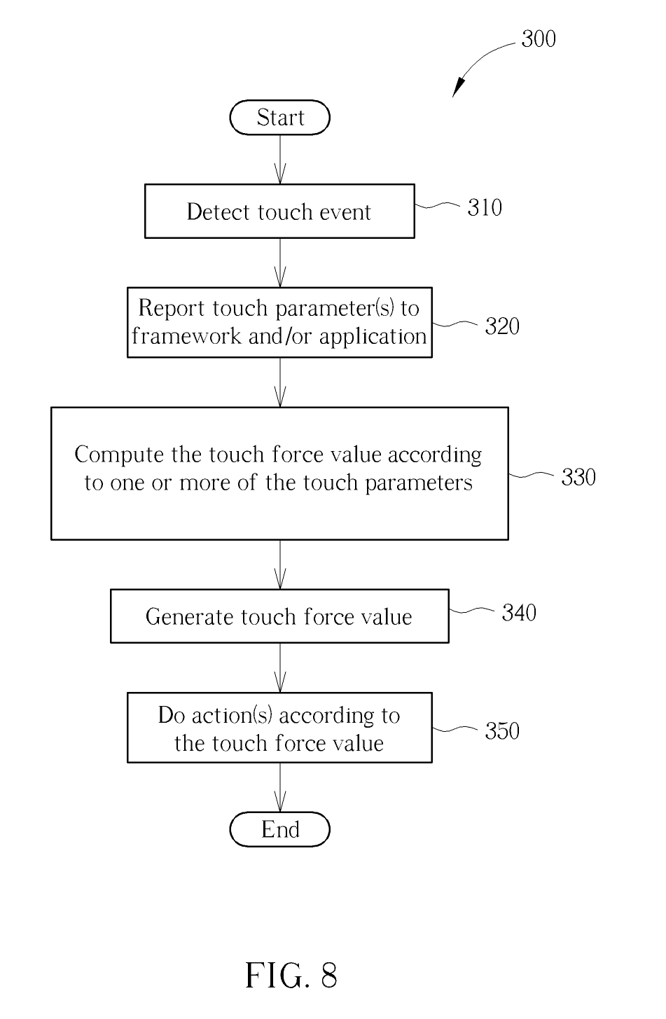

FIG. 8 illustrates a working flow 300 involved with the method 200 shown in FIG. 3 according to an embodiment of the present invention. For example, the processing circuit 110 may comprise a touch panel controller for performing the operation of Step 210. The touch sensor controller mentioned above can be taken as an example of the touch panel controller in this embodiment.

In Step 310, the processing circuit 110 (e.g. the touch panel controller) may detect a touch event such as that mentioned above.

In Step 320, the processing circuit 110 (e.g. the touch panel controller) may report touch parameter(s) to a framework and/or an application, where the framework and/or application can be taken as examples of the program modules mentioned in some of the above embodiments.

In Step 330, the processing circuit 110 (e.g. the framework and/or application running on the aforementioned at least one processor or the aforementioned at least one processor core) may compute the touch force value associated with the touch event according to one or more of the touch parameters, such as an estimated touch point (e.g. the location thereof), an estimated area, an estimated duration, an estimated proximity value, an estimated touch action (e.g. down, up, move, etc.), and any of other types of parameters associated with the touch event.

In Step 340, the processing circuit 110 may generate the touch force value.

In Step 350, the processing circuit 110 may do action(s) (e.g. one or more of the plurality of predetermined operations) according to the touch force value. Examples of the action(s) may include, but not limited to, vibration, sound, change user interface (UI), and any of other types of actions.

According to some embodiments, the touch panel controller may be positioned outside the processing circuit 110, where the touch panel controller may detect the touch event in Step 310, and may report the touch parameter(s) to the framework and/or an application. For brevity, similar descriptions for these embodiments are not repeated in detail here.

According to some embodiments, in Step 330, the processing circuit 110 (e.g. the framework and/or application running on the aforementioned at least one processor or the aforementioned at least one processor core) may define multiple ranges of touch area such as the three ranges of touch area {TA_SMALL, TA_MEDIUM, TA_BIG}, multiple ranges of touch duration such as the three ranges of touch duration {TD_SHORT, TD_MEDIUM, TD_LONG}, and multiple touch force values such as the two touch force values {TF_LIGHT, TF_HEAVY}, which may have the following relationships:

TA_SMALL<TA_MEDIUM<TA_BIG;

TD_SHORT<TD_MEDIUM<TD_LONG; and

TF_LIGHT<TF_HEAVY;

where the number of ranges of touch area, the number of ranges of touch duration, and the number of touch force values may vary in different examples. In one example, the processing circuit 110 may compute the touch force value as shown in the following pseudo codes:

if (touch_area == TA_SMALL &&

touch_duration == TD_SHORT)
touch_force = TF_LIGHT;

else if (touch_area == TA_BIG &&

touch_duration == TD_LONG)
touch_force = TF_ HEAVY;

where the parameters touch_area, touch_duration, and touch_force may represent the estimated area, the estimated duration, and the touch force value, respectively. In this example, when the estimated area falls within the range TA_SMALL and the estimated duration falls within the range TD_SHORT, the touch force value may be determined as TF_LIGHT, which may mean the touch event is determined as a light touch. When the estimated area falls within the range TA_BIG and the estimated duration falls within the range TD_LONG, the touch force value may be determined as TF_HEAVY, which may mean the touch event is determined as a heavy touch. For brevity, similar descriptions for these embodiments are not repeated in detail here.

According to some embodiments, the touch event may comprise a touchless user-input (e.g. the fingertip of a finger of the user maybe close to but not contact the touch-sensitive module 120), where at least one portion of the aforementioned at least one touch parameter may indicate a degree of proximity that the user of the electronic device applies to the touch-sensitive module 120 in the touch event. For example, in a situation the touch-sensitive module 120 such as the touch screen belongs to a capacitive type, the one or more detection signals may correspond to the strength of electric fields and/or variations of the strength of electric fields, to allow the processing circuit 110 to detect the degree of proximity that the user of the electronic device applies to the touch-sensitive module 120 in the touch event. In some embodiments, the touch force value maybe positively correlated with the estimated proximity value. For example, when the proximity value is large, which may mean the fingertip of the user is very close to the touch-sensitive module 120, the touch event may be determined as a heavy touch. In another example, when the proximity value is small, which may mean the fingertip of the user is not very close to the touch-sensitive module 120, the touch event may be determined as a light touch. For brevity, similar descriptions for these embodiments are not repeated in detail here.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing user-input control in an electronic device, the method comprising the steps of:
obtaining at least one touch parameter of a touch event regarding a touch-sensitive module of the electronic device, wherein the touch-sensitive module does not comprise a pressure sensor;
determining a touch force value associated with the touch event according to the at least one touch parameter; and
selecting a predetermined operation from a plurality of predetermined operations according to the touch force value, to control the electronic device to perform the predetermined operation in response to the touch force value.

2. The method of claim 1, wherein the touch force value indicates force that a user of the electronic device applies to the touch-sensitive module in the touch event.

3. The method of claim 1, wherein the at least one touch parameter comprises an estimated area associated with the touch event.

4. The method of claim 3, wherein the touch force value is positively correlated with the estimated area.

5. The method of claim 1, wherein the at least one touch parameter comprises an estimated duration associated with the touch event.

6. The method of claim 5, wherein the touch force value is positively correlated with the estimated duration.

7. The method of claim 1, wherein the at least one touch parameter comprises an estimated proximity value associated with the touch event.

8. The method of claim 7, wherein the touch force value is positively correlated with the estimated proximity value.

9. The method of claim 1, wherein the touch event comprises a touchless user-input, wherein at least one portion of the at least one touch parameter indicates a degree of proximity that a user of the electronic device applies to the touch-sensitive module in the touch event.

10. The method of claim 1, wherein the at least one touch parameter of the touch event is obtained from the touch-sensitive module or is obtained by processing one or more detection signals received from the touch-sensitive module.

11. An apparatus for performing user-input control in an electronic device, the apparatus comprising:
a processing circuit, positioned within the electronic device and coupled to a touch-sensitive module of the electronic device, arranged for obtaining at least one touch parameter of a touch event regarding the touch-sensitive module of the electronic device, determining a touch force value associated with the touch event according to the at least one touch parameter, and selecting a predetermined operation from a plurality of predetermined operations according to the touch force value, to control the electronic device to perform the predetermined operation in response to the touch force value, wherein the touch-sensitive module does not comprise a pressure sensor.

12. The apparatus of claim 11, wherein the touch force value indicates force that a user of the electronic device applies to the touch-sensitive module in the touch event.

13. The apparatus of claim 11, wherein the at least one touch parameter comprises an estimated area associated with the touch event.

14. The apparatus of claim 13, wherein the touch force value is positively correlated with the estimated area.

15. The apparatus of claim 11, wherein the at least one touch parameter comprises an estimated duration associated with the touch event.

16. The apparatus of claim 15, wherein the touch force value is positively correlated with the estimated duration.

17. The apparatus of claim 11, wherein the at least one touch parameter comprises an estimated proximity value associated with the touch event.

18. The apparatus of claim 17, wherein the touch force value is positively correlated with the estimated proximity value.

19. The apparatus of claim 11, wherein the touch event comprises a touchless user-input, wherein at least one portion of the at least one touch parameter indicates a degree of proximity that a user of the electronic device applies to the touch-sensitive module in the touch event.

20. The apparatus of claim 11, wherein the at least one touch parameter of the touch event is obtained from the touch-sensitive module; or the processing circuit processes one or more detection signals received from the touch-sensitive module, to generate the at least one touch parameter of the touch event.
